(19) United States
(12) Patent Application Publication
(10) Pub. No.: US 2026/0128671 A1
(43) Pub. Date: May 7, 2026

(54) STACKED POWER CONVERTER ASSEMBLIES

(71) Applicant: Infineon Technologies Austria AG, Villach (AT)

(72) Inventors: Sutej Reddy CHALLA, Action, MA (US); EungSan CHO, Torrance, CA (US); Darryl TSCHIRHART, Newmarket (CA); Danny R. Clavette, Greene, RI (US); Wenkang Huang, East Greenwich, CT (US); Darryl Galipeau, Warwick, RI (US); Matthew STRAAYER, Acton, MA (US)

(21) Appl. No.: 18/936,312

(22) Filed: Nov. 4, 2024

(51) Int. Cl. H02M 3/00; H02M 3/158

(52) U.S. Cl. CPC H02M 3/015; H02M 3/1584

(57) ABSTRACT

A power converter assembly includes a stack of circuit components to convert an input voltage into an output voltage. The stack of circuit components may include: a first component layer including driver circuitry; a second component layer including multiple switches controlled by the driver circuitry in the first component layer; and a third component layer disposed between the first component layer and the second component layer, the third component layer comprising at least one capacitor component to support conversion of the input voltage into the output voltage. In another implementation, the power converter assembly includes: a first component layer including at least one capacitor component of the power converter; a second component layer coupled to the first component layer, the second component layer including driver circuitry and multiple switches; and a third component layer including at least one inductor.

### BACKGROUND

Conventional switching power supply circuits sometimes include an energy storage component such as an inductor to produce an output voltage that powers a load. For example, to maintain a magnitude of an output voltage within a desired range, a controller controls switching of input current through one or more inductors.

In general, a conventional inductor is a component comprising wire or other conductive material, which is shaped as a coil or helix to increase an amount of magnetic flux through a respective circuit path. Winding a wire into a coil of multiple turns increases the number of respective magnetic flux lines in a respective inductor component, increasing the magnetic field and thus overall inductance of the respective inductor component.

Certain conventional power converters include a stacking of components to convert a respective input voltage into an output voltage.

### BRIEF DESCRIPTION

Examples herein provide novel and improved inductor components as well as novel and improved stacked power converter topologies.

### Power Converter Assembly Including First Stack of Circuit Components

First examples herein include a novel power converter assembly and a method of fabricating same.

In one example, an apparatus as discussed herein includes a power converter assembly. The power converter assembly comprises a stack of circuit components. The power converter assembly and stack of circuit components is operative to convert an input voltage into an output voltage. The stack of circuit component can be configured to include: a first component layer including switch driver circuitry; a second component layer including multiple switches controlled by the switch driver circuitry in the first component layer; and a third component layer disposed between the first component layer and the second component layer, the third component layer comprising at least one capacitor component to support conversion of the input voltage into the output voltage.

In another example, as discussed herein, the apparatus and corresponding stack of circuit components may include electrically conductive paths extending through the third component layer, where the electrically conductive paths operative to convey control signals from the switch driver circuitry to the multiple switches.

Additionally, the apparatus as discussed herein may be configured to include: a first redistribution layer disposed between the first component layer and the third component layer; and a second redistribution layer disposed between the third component layer and the second component layer.

Yet further, the multiple switches in the second component layer may include a first switch circuit and a second switch circuit; and a circuit component may be disposed in the second component layer between the first switch circuit and the second switch circuit.

In another example, the at least one capacitor component includes: a first capacitor operative to store the input voltage; a second capacitor operative to store a driver voltage used by the switch driver circuitry; and a third capacitor operative to store the output voltage.

In still further examples, the at least one capacitor component may include: a bootstrap capacitor connected between the switch driver circuitry in the first component layer and a first axial end of a first electrically conductive path in a third component layer of the power converter assembly. In one example, the bootstrap capacitor is connected to two switches.

As another example, the stack of circuit components may include: a fourth component layer comprising: magnetically permeable material; and a first electrically conductive path encompassed by the magnetically permeable material. The first electrically conductive path can be configured to convey first current in a first direction away from the second component layer through the fourth component layer to a load. The power converter assembly may further include a second electrically conductive path encompassed by the magnetically permeable material, the second electrically conductive path operative to convey the first current in a second direction from the load through the fourth component layer. The second electrically conductive path may be fabricated from a single homogeneous element of metal extending through the fourth component layer, where the second electrically conductive path is disposed between the first electrically conductive path and a third electrically conductive path in the fourth component layer, and where the third electrically conductive path is operative to convey second current in the first direction to the load.

Still further, and assembly as discussed herein can be configured to include a host substrate and a load. The stack of circuit components may be disposed between the host substrate and the dynamic load, where the stack of circuit components is operative to receive the input voltage from the host substrate and supply the output voltage to the dynamic load. The load or dynamic load represents Central Processor Unit, Graphic Processor Unit, ASIC, FPGA, or other devices.

Yet further, note that the second component layer includes at least one capacitor.

In accordance with further examples as discussed herein, the apparatus may include a host package substrate including a cavity. The stack of circuit components may be disposed in a host package substrate.

Still further, the third component layer may be fabricated from any suitable material such as one or more of: i) glass, ii) silicon; and/or iii) a multi-compound layer of material.

### Power Converter Assembly Including Second Stack of Circuit Components

Second examples herein include a novel stacked power converter and a method of fabricating same.

For example an apparatus as discussed herein may include a power converter assembly comprising a stack of power converter components, where the power converter assembly is operative to convert an input voltage into an output voltage. The stack of power converter components can be configured to include: a first component layer including at least one capacitor component; a second component layer coupled to the first component layer, the second component layer including switch driver circuitry and multiple switches, the multiple switches controlled by the switch driver circuitry; a third component layer coupled to the second component layer, the third component layer including at least one inductor; and wherein the second component layer is disposed between the first component layer and the third component layer.

In a further example, the apparatus as discussed herein includes a first redistribution substrate disposed between the first component layer and the second component layer; and a second redistribution substrate disposed between the second component layer and the third component layer.

Still further, the at least one capacitor component may include: a first capacitor operative to store the input voltage; and a second capacitor operative to store a driver voltage used by the driver circuitry.

Yet further, the third component layer may include: magnetically permeable material; and a first electrically conductive path encompassed by the magnetically permeable material, the first electrically conductive path extending axially from a first node disposed on a first surface of the third component layer and a second node disposed on a second surface of the third component layer, the second surface disposed opposite the first surface. The first electrically conductive path can be configured to convey first current received from the second component layer through the third component layer in a first direction to a load, the apparatus further comprising: a second electrically conductive path encompassed by the magnetically permeable material, the second electrically conductive path operative to convey the first current in a second direction from the load through the third component layer to the second component layer.

In another example, the second electrically conductive path is a single homogeneous element of metal extending through the third layer, where the second electrically conductive path is disposed between the first electrically conductive path and a third electrically conductive path in the third component layer. The third electrically conductive path can be configured to convey second current in the first direction. The second electrically conductive path can be configured to convey the second current in the second direction from the load through the third component layer to the second component layer.

Yet another example as discussed herein may include an assembly comprising: a host substrate; a stack of circuit components coupled to the host substrate; and a dynamic load coupled to the stack of circuit components. The stack of circuit components may be disposed between the host substrate and the dynamic load, where the stack of circuit components is operative to receive the input voltage from the host substrate and supply the output voltage to the dynamic load.

### Power Converter Assembly Including Third Stack of Circuit Components

As further discussed herein, an apparatus can be configured to include a power converter assembly. The power converter assembly may include a stack of power converter components. The power converter assembly may be operative to convert an input voltage into an output voltage. In one example, the stack of power converter components includes: a first component layer including switch driver circuitry; a second component layer coupled to the first component layer, the second component layer including multiple switches controlled by the switch driver circuitry; a third component layer coupled to the second component layer, the third component layer including at least one inductor; and wherein the second component layer is disposed between the first component layer and the third component layer.

In a further example, the apparatus further includes: a first redistribution substrate disposed between the first component layer and the second component layer; and a second redistribution substrate disposed between the second component layer and the third component layer.

In still further examples, note that the third component layer can be configured to include: magnetically permeable material; and a first electrically conductive path encompassed by the magnetically permeable material, the first electrically conductive path extending axially from a first node disposed on a first surface of the third component layer and a second node disposed on a second surface of the third component layer, the second surface disposed opposite the first surface.

Still further, the first electrically conductive path can be configured to convey first current received from the second component layer through the third component layer in a first direction to a load. The apparatus may further include a second electrically conductive path encompassed by the magnetically permeable material, the second electrically conductive path operative to convey the first current in a second direction from the load through the third component layer to the second component layer.

Additionally, another assembly as discussed herein may include: a host substrate; the stack of circuit components coupled to the host substrate; a dynamic load coupled to the stack of circuit components; and wherein the stack of circuit components is disposed between the host substrate and the dynamic load, the stack of circuit components operative to receive the input voltage from the host substrate and supply the output voltage to the dynamic load.

These and other more specific examples are disclosed in more detail below.

Note further that although examples as discussed herein are applicable to switching power supplies, the concepts disclosed herein may be advantageously applied to any other suitable topologies.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating side view of a circuit assembly including multiple power converter phases as discussed herein.

FIG. 2 is an example diagram illustrating stacking of circuit components in a power converter assembly as discussed herein.

FIG. 3 is an example diagram illustrating stacking of circuit components in a power converter assembly as discussed herein.

FIG. 4 is an example circuit diagram illustrating implementation of multiple power converters and respective power converter phases in a power converter assembly as discussed herein.

FIG. 5 is an example circuit diagram illustrating implementation of multiple power converters and respective power converter phases in a power converter assembly as discussed herein.

FIG. 6 is an example circuit diagram illustrating implementation of multiple power converters and respective power converter phases in a power converter assembly as discussed herein.

FIG. 7 is an example side view diagram of a power converter assembly disposed in a substrate package where the substrate package is disposed between a host substrate and a load as discussed herein.

FIG. 8 is an example side view diagram illustrating a multilayer power converter assembly as discussed herein.

FIG. 9 is an example three-dimensional diagram illustrating implementation of a multilayer power converter circuit assembly as discussed herein.

FIG. 10 is an example side view diagram illustrating a power converter assembly as discussed herein.

FIG. 11 is an example side view diagram of a power converter assembly disposed in a substrate package and wherein the substrate package is disposed between a host substrate and a load as discussed herein.

FIG. 12 is a top view diagram of a power converter assembly illustrating multiple electrically conductive paths passing through magnetically permeable material as discussed herein.

FIG. 13 is an example side diagram illustrating fabrication of a power converter assembly as discussed herein.

FIG. 14 is an example side diagram illustrating fabrication of the power converter assembly is discussed herein.

FIG. 15 is an example side diagram illustrating fabrication of the power converter assembly as discussed herein.

FIG. 16 is an example side diagram illustrating fabrication of the power converter assembly as discussed herein.

FIG. 17 is an example diagram illustrating stacking of circuit components in a power converter assembly as discussed herein.

The foregoing and other objects, features, and advantages of examples herein will be apparent from the following more particular description herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

Certain examples as discussed herein include a power converter assembly such as a so-called Substrate Integrated Voltage Regulator (SIVR) module to provide power conversion. The power converter assembly can be configured to provide high voltage conversion efficiency, high power density, and may be able to convert a respective one or more input voltage (potentially of high magnitudes) into a respective one or more output voltages.

Further, the high-efficiency power converter assembly as discussed herein can be embedded in a so-called SoC (System on Chip) assembly. The so-called SIVR module as discussed herein achieves high density by stacking one or more inductors, power switches (MOSFET or GaN HEMT), and driver circuitry within close proximity of each other. One example as discussed herein include a potentially thin interposer (such as silicon/glass/RDL, where RDL is a so-called ReDistribution Layer) sandwiched between a power switch layer (including one or more switches) and a switch driver circuitry layer, which allows for low parasitic routing (such as providing low parasitic capacitance, low parasitic inductance, and low parasitic resistance) and high density trace routing between the driver circuitry layer and the power switch layer.

In one example, one or more so-called through silicon vias in the interposer layer (such as a silicon interposer or copper post in RDL) enable efficient vertical power delivery through a stack of power converter components. High input voltages (such as 6.75 VDC nominal or other suitable magnitude input voltage) to SoC BGA (Ball Grid Array) solder balls can be configured to increase power throughput into the SoC package and also minimize losses in input PDN (Power Distribution Network). Proximity of the power converter assembly to a respective load such as a processor or other suitable one or more devices minimizes output PDN impedance and thus improves dynamic response for load transients.

Thus, one example as discussed herein includes stacking of one or more inductors, one or more power switches, and driver circuitry including a silicon interposer (or other type of interposer) to achieve high output current density and high efficiency of delivering power vertically through the stack of power converter components (power converter assembly).

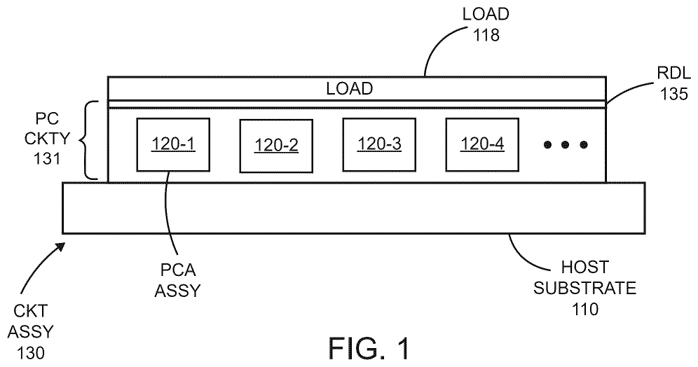

Now, more specifically, with reference to the drawings, FIG. 1 is an example diagram illustrating side view of a circuit assembly including multiple power converter phases as discussed herein.

As shown in FIG. 1, the circuit assembly 130 includes substrate 110, power converter circuitry 131, and load 118.

In this example, the power converter circuitry 131 disposed between the substrate 110 and the load 118 receives one or more input voltages from the substrate 110 or other suitable entity and converts them into one or more output voltages supplied through the redistribution layer 135 to the load 118.

The power converter circuitry 131 disposed between the substrate 110 and the load 118 may include any number of power converter assemblies 120 (such as power converter assembly 120-1, power converter assembly 120-2, power converter assembly 120-3, power converter assembly 120-4, etc.) to convert one or more input voltages into one or more output voltages to power the load 118.

In this example, the power converter circuitry 131 includes power converter assembly 120-1 such as a first power converter phase, power converter assembly 120-2 such as a second power converter phase, power converter assembly 120-3 such as a third power converter phase, and power converter assembly 120-4 such as a fourth power converter phase, etc.

Note again that the power converter circuitry 131 can be configured to include any number of power converter assemblies.

Each of the power converter assemblies in the power converter circuitry 131 can be connected in parallel with one or more other power converter assemblies. Alternatively, each of the power converter assemblies may be operated independently to convert a respective input voltage into an output voltage.

As further shown, the circuit assembly 130 may include a so-called redistribution layer 135 providing connectivity between the power converter circuitry 131 and the load 118. The redistribution layer 135 can be implemented as a single or multilayer substrate providing connectivity between the power converter assemblies 120 and the load 118. Inclusion of the redistribution layer 135 and corresponding electrically conductive paths in the redistribution layer 135 provides vertical connectivity between the power converter circuitry 131 and the different pins of the load 118 or other circuit component coupled to the top surface of the redistribution layer 135.

As previously discussed, each of the power converter assemblies 120 can be configured to include one or more power converter phases. The power converter phases, if desired, can be connected in parallel to collectively convert a received input voltage into a respective output voltage powering the load 118.

Yet further, as discussed herein, each of the power converter assemblies 120 can be configured to include a stack of multiple circuit components. Collectively, as well as individually, in one example, each of the power converter assemblies 120 supports vertical power conversion and corresponding vertical flow of power from the substrate 110 to the load 118. For example, each of the power converter assemblies 120 can be configured to receive power from the substrate 110 and vertically convey the received power (energy) in a direction vertically from the substrate 110 to the load 118.

Additional details of different implementations of power converter assemblies is further discussed in the following drawings and corresponding description.

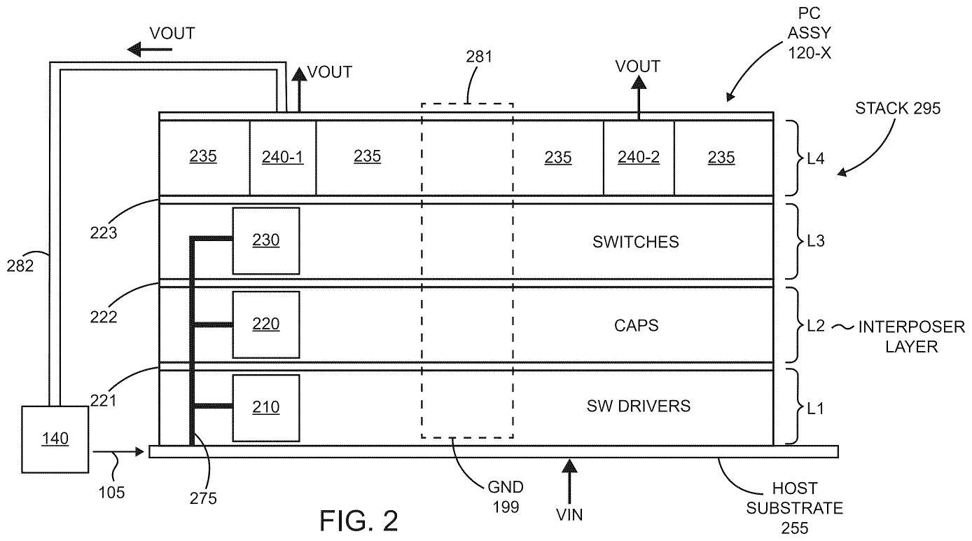

FIG. 2 is an example diagram illustrating stacking of circuit components in a power converter assembly as discussed herein.

In this example, the power converter assembly 120-X (such as illustrating each instance of power converter assembly 120-1 [X=1], power converter assembly 120-2 [X=2], power converter assembly 120-3 [X=3], power converter assembly 120-4 [X=4], etc.) can be configured to include multiple layers (stack) of circuit components.

As previously discussed, the stack of circuit components in each power converter assembly supports conversion of a respective one or more input voltages (such as including input voltage Vin) into one or more output voltages (such as including output voltage Vout, Vout1, Vout2, Vout11, Vout12, Vout 13, and so on).

More specifically, in this example, the stack 295 of circuit components associated with the power converter assembly 120-X (such as an instance of the power converter assembly 120-1, power converter 120-2, power converter 120-3, etc.) includes a first layer L1 of circuit components including switch driver circuitry and potentially other circuitry; a second layer L2 (such as a so-called interposer layer) of circuit components including one or more capacitors and potentially other circuitry; a third layer L3 of circuit components including one or more instances of switch circuitry and potentially other circuitry; and a fourth layer L4 of circuit components including one or more inductors and/or electrically conductive paths.

The switch circuitry 230 (such as one or more switches) disposed in the third layer L3 are controlled by the switch driver circuitry 210 (such as one or more driver circuits) disposed in the first layer L1.

The second layer L2 such as a so-called interposer layer or other suitable entity can be configured to include multiple capacitors 220 supporting conversion of the one or more input voltages into the one or more output voltages.

In one example, the component layer L2 such as an interposer layer is fabricated from one or more material such as: i) glass, ii) silicon; iii) a multi-compound layer of material, etc.

It is further noted that the power converter assembly 120-X can be configured to include any number of so-called redistribution layers (a.k.a., substrates, printed circuit boards, etc.).

For example, the power converter assembly 120-X can be configured to include a redistribution layer 221 disposed between the first layer L1 and the second layer L2. The power converter assembly 120-X can be configured to include a redistribution layer 222 disposed between the second layer L2 and the third layer L3. The power converter assembly 120-X can be configured to include a redistribution layer 223 disposed between the third layer L3 and the fourth layer L4.

Yet further, as shown, the fourth layer L4 can be configured to include any number of electrically conductive paths extending through the magnetically permeable material 235. For example, the electrically conductive paths 240 in the fourth layer L4 can be configured to include electrically conductive path 240-1, electrically conductive path 240-2, electrically conductive path 240-3, electrically conductive path 240-4, etc.

Each of the electrically conductive paths 240 in the fourth layer L4 may be surrounded by the magnetically permeable material 235. In such an instance, each of the electrically conductive paths 240 in the fourth layer L4 is an inductor device operative to support vertical conveyance of power (such as current) through the stack from the third layer L3 and further through the layer L4 out the top of the respective stack 295 of layers (L1, L2, L3, L4).

As further discussed herein, the power converter assembly 120-X can be configured to include any suitable network of electrically conductive paths 275 providing connectivity amongst the different layers in the stack 295 including component layer L1, component layer L2, component layer L3, and component layer L4. It is noted that the electrically conductive paths 275 may extend vertically from one redistribution layer to the next redistribution layer.

Additionally, the electrically conductive paths 275 may extend horizontally in the one or more redistribution layers 221, 222, 223, etc.

Accordingly, as further discussed herein, the network of electrically conductive paths 275 can be configured to include multiple electrically conductive paths extending through each of the layers including layer L1, layer L2, layer L3, and layer L4, as well corresponding redistribution layer such as redistribution layer 220, redistribution layer 221, redistribution layer 222, redistribution layer 223, etc.

In one example, the controller 140 can be disposed in the stack 295 or outside of the stack 295 of layers including layer L1, layer L2, layer L3, and layer L4.

Note further that the controller 140 can be configured to generate control signals 105 to control operation of the respective switch circuitry in layer L3 supporting control of current through the stack 295.

A portion of the network of electrically conductive paths 275 can be configured to convey the control signals from the controller 140 to the switch driver circuitry 210 disposed in the layer L1. As further discussed herein, the driver circuitry 210 further generates corresponding control signals conveyed by the network of electrically conductive paths 275 to the switches 230 (such as one or more of switch Q11, switch Q12, switch Q21, switch Q22, switch Q31, switch Q32, switch Q41, switch Q42, etc.) in the layer L3.

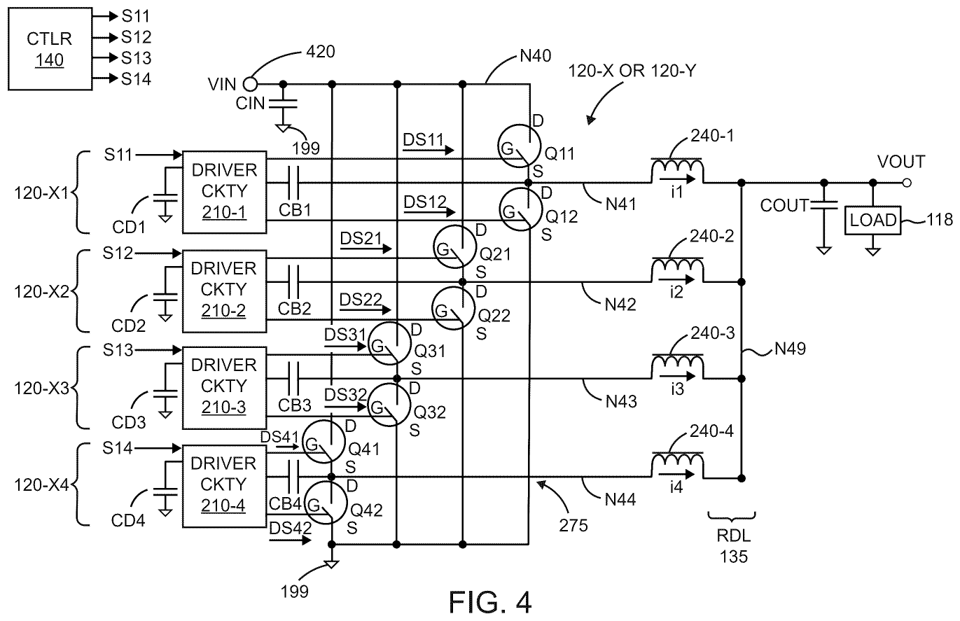

Note that additional details of the network of electrically conductive paths 275 and connectivity is shown in circuit diagrams of FIGS. 4 through 6.

Referring again to FIG. 2, thus, the power converter assembly 120-X can be configured to include one or more electrically conductive paths extending through the stack 295 of layers. In one example, a first electrically conductive path such as electrically conductive path 281 is connected to a ground reference voltage 199 (a.k.a., ground reference potential). In one example, the electrically conductive path 281 through the stack 295 is enveloped by the magnetic permeable material 235. In such an instance, the electrically conductive path 281 is itself an inductor in a return path from the top of the power converter assembly 120-X through the stack 295 as shown to the ground reference 199. In alternative examples, note that the electrically conductive path 281 may not pass through the stack 295 and instead be implemented in a clip or other conductive path outside of the stack 295.

All or a portion of the electrically conductive path 281 may be a single homogeneous element of electrically conductive material. Alternatively, the electrically conductive path 281 may include multiple portions of different electrically conductive paths connected to each other. Additional details of implementing the electrically conductive path 281 are discussed in the following FIGS.

Yet further, referring again to FIG. 2, the power converter assembly 120-X can be configured to include a respective electrically conductive path 282 (such as a return electrically conductive path, a metal clip, etc.) extending through or outside of the power converter assembly 120-X from a top portion of the stack 295 back down to the controller 140. As previously discussed, the stack 295 and corresponding components can be configured to convert a respective input voltage Vin into an output voltage Vout. In one example, the electrically conductive path 282 supports feedback of the respective output voltage itself or a signal indicating a magnitude of the output voltage back to the controller 140.

The power converter assembly 120-X can include any number of electrically conductive return paths.

If desired, the controller 140 can be configured to regulate the magnitude of the one or more output voltages outputted from the top of the stack 295 based on comparing a respective output voltage feedback signal conveyed over the electrically conductive path 282 to a corresponding setpoint reference voltage and adjusting (via modifying control signals 105 controlling the switch circuitry in layer L3) operation of the switches in the layer L3 such that the current through each of the electrically conductive paths 240 in layer L4 results in generation of the respective output voltage within a desired range.

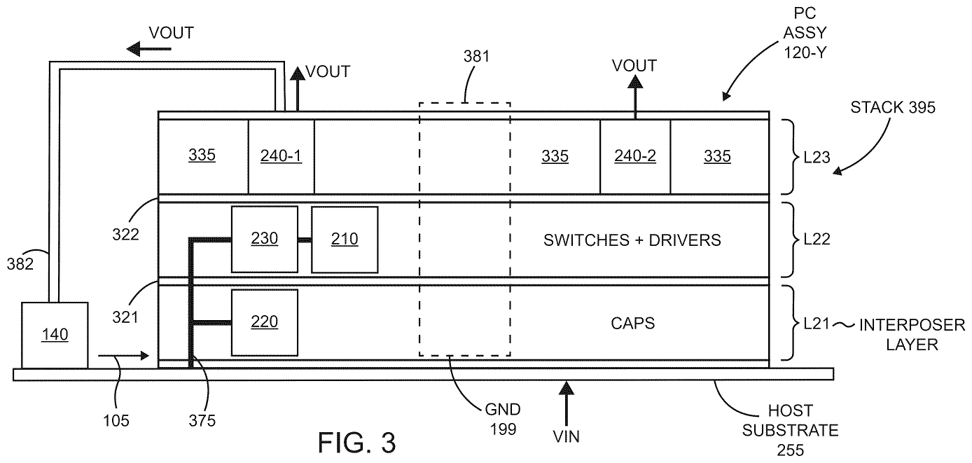

FIG. 3 is an example diagram illustrating stacking of circuit components in a power converter assembly as discussed herein.

In this example, the power converter assembly 120-Y such as illustrating each instance of power converter assembly 120-1 [Y=1], power converter assembly 120-2 [Y=2], power converter assembly 120-3 [Y=3], power converter assembly 120-4 [Y=4], etc.) can be configured to include multiple layers (stack) of circuit components.

As previously discussed, the stack 395 of circuit components in each power converter assembly supports conversion of a respective one or more input voltages (such as including input voltage Vin) into one or more output voltages (such as including output voltage Vout, Vout1, Vout2, Vout11, Vout12, Vout13, and so on).

More specifically, in this example, the stack 395 of circuit components associated with the power converter assembly 120-Y includes a layer L21 (such as a silicon interposer layer) of circuit components including one or more capacitors and potentially other circuitry; a second layer L22 of circuit components including switch driver circuitry, switch circuitry, and potentially other circuitry; a third layer L23 of circuit components including one or more inductors.

The switch circuitry (such as one or more switches) disposed in the layer L22 are controlled by the switch driver circuitry (such as one or more driver circuits) disposed in the second layer L22.

The layer L21 may be a so-called interposer layer or other suitable entity and can be configured to include multiple capacitors supporting conversion of the one or more input voltages into the one or more output voltages.

In general, in one example, an interposer such as in layer L21 is a device or entity that allows electrical signals to pass between boards or sockets and which may include one or more circuit components fabricated within the layer L21. As previously discussed, the interposers as discussed herein can be fabricated from silicon, glass, etc. Thus, the component layer L21 such as an interposer layer can be fabricated from one or more material such as: i) glass, ii) silicon; iii) a multi-compound layer of material, etc.

It is further noted that the power converter assembly 120-Y can be configured to include any number of so-called redistribution layers (a.k.a., substrates, printed circuit boards, etc.).

For example, the power converter assembly 120-Y can be configured to include a redistribution layer 321 disposed between the layer L21 and the layer L22. The power converter assembly 120-Y can be configured to include a redistribution layer 322 disposed between the layer L22 and the layer L23.

Yet further, as shown, the layer L23 can be configured to include any number of electrically conductive paths (inductive paths) extending through the magnetically permeable material 335. For example, the electrically conductive paths 240 in the layer L23 can be configured to include electrically conductive path 240-1, electrically conductive path 240-2, electrically conductive path 240-3, electrically conductive path 240-4, etc.

Each of the electrically conductive paths 240 in the layer L23 may be surrounded by the magnetically permeable material 335. In such an instance, each of the electrically conductive paths 240 in the layer L23 is an inductor device operative to support vertical conveyance of power through the stack 395 the third layer L23 out the top of the respective stack of layers (L21, L22, L23).

As further discussed herein, the power converter assembly 120-Y can be configured to include any suitable network of electrically conductive paths 375 providing connectivity amongst the different layers in the stack 395 including component layer L21, component layer L22, and component layer L23.

As further discussed herein, the network of electrically conductive paths 375 can be configured to include multiple electrically conductive paths extending through each of the layers including layer L21, layer L22, as well corresponding redistribution layer such as redistribution layer 321, redistribution layer 322, etc.

In one example, the controller 140 can be disposed in the stack 395 or outside of the stack 395 of layers including layer L21, layer L22, layer L23. Note further that the controller 140 can be configured to generate control signals 105 to control operation of the respective switch circuitry in layer L22 supporting control of current and power through the stack 395.

The network of electrically conductive paths 375 can be configured to convey the control signals from the controller 140 to the switch driver circuitry 210 disposed in the layer L22. The driver circuitry 210 further generates corresponding control signals conveyed by the network of electrically conductive paths 375 to the switch circuitry 230 (such as one or more of switch Q11, switch Q12, switch Q21, switch Q22, switch Q31, switch Q32, switch Q41, switch Q42, etc.) in the layer L22.

Note that additional details of the network of electrically conductive paths 375 and connectivity is shown in circuit diagrams of FIGS. 4 through 6.

Referring again to FIG. 3, thus, the power converter assembly 120-Y can be configured to include one or more electrically conductive paths extending through the stack 395 of layers. In one example, a first electrically conductive path such as electrically conductive path 381 is connected to a ground reference voltage 199. All or a portion of the electrically conductive path 381 may be a single homogeneous element or multiple segments of connected electrically conductive material. Additional details of implementing the electrically conductive path 281 are discussed in the following FIGS.

Yet further, referring again to FIG. 3, the power converter assembly 120-Y can be configured to include a respective electrically conductive path 382 (such as a return electrically conductive path) extending from a top portion of the stack 395 back down to the controller 140. As previously discussed, the stack 395 and corresponding components can be configured to convert a respective input voltage into an output voltage. In one example, the electrically conductive path 382 supports feedback of the respective output voltage back to the controller 140. The power converter assembly 120-Y can include any number of electrically conductive return paths.

In one example, the electrically conductive path 381 through the stack 395 is enveloped by the magnetic permeable material 335. In such an instance, the electrically conductive path 381 is itself an inductor in a return path from the top of the power converter assembly 120-Y through the stack 395 as shown to the ground reference 199. In alternative examples, note that the electrically conductive path 381 may not pass through the stack 395 and instead be implemented in a clip or other conductive path outside of the stack 395.

If desired, the controller 140 can be configured to regulate the magnitude of the one or more output voltages outputted from the top of the stack 395 based on comparing a respective output voltage feedback signal received over the electrically conductive path 382 to a setpoint reference voltage and adjusting (via modifying control signals 105 controlling the switch circuitry in layer L22) operation of the switches in the layer L22 such that the current through each of the electrically conductive paths 240 in layer L3 results in generation of the respective output voltage within a desired range.

FIG. 4 is an example circuit illustrating implementation of multiple power converter phases in a power converter assembly as discussed herein.

As previously discussed, the power converter circuitry 131 (FIG. 1) disposed between the substrate 110 and the load 118 can be configured to include any number of power converter assemblies 120-X (FIG. 2) or 120-Y (FIG. 3).

In this example of FIG. 4, each power converter assembly includes multiple individual power converters connected in parallel to produce a respective output voltage Vout to power the load 118.

### Power Converter 120-X1

For example, a first power converter 120-X1 may be disposed in the respective power converter assembly 120-X or 120-Y and may be configured to include a capacitor CD1, driver circuitry 210-1, bootstrap capacitor CB1, switch Q11, switch Q12, and inductor 240-1. In one example, the combination of switch Q11, switch Q12, and inductor 240-1 (electrically conductive path) is a buck converter.

The capacitor CD1 can be configured to store a respective voltage used by the driver circuitry 210-1 to produce respective drive signals DS11 and DS12 to control respective switch Q11 and switch Q12. In general, during operation of converting the input voltage Vin into the output voltage Vout, the controller 140 is configured to activate and deactivate the multiple switches Q11 and Q12 during a respective control cycle to control conveyance of a respective current through the inductor 240-1 to the capacitor COUT and corresponding load 118.

More specifically, for a first portion of a control cycle of controlling the respective switches Q11 and Q12, the controller 140 generates the control signals S11 causing the driver circuitry 210-1 to produce the control signal DS11 to activate the switch Q11 to an ON-state (i.e., low impedance path) and produce the control signal DS12 to deactivate the switch Q12 to an OFF-state (i.e., high impedance path). Conversely, for a second portion of a control cycle of controlling the respective switches Q11 and Q12, the controller 140 generates the control signals S11, causing the driver circuitry 210-1 to produce the control signal DS11 to deactivate the switch Q11 to an OFF-state (i.e., high impedance path) and produce the control signal DS12 to activate the switch Q12 to an ON-state (i.e., low impedance path). Switching of the switches 230 such as including Q11 and Q12 on and off for each of multiple control cycles controls a magnitude of the current i1 supplied by the inductor 240-1 to the load 118.

As further shown, the capacitor CIN stores the input voltage VIN supplied by the power source 420.

The capacitor CB1 is a so-called bootstrap capacitor connected between the driver circuitry 210-1 and the node N41. The node N41 directly connects the switch Q11 and the switch Q12 in series between the node N40 and the ground reference voltage 199. For example, the drain node D of the switch Q 11 is directly connected to the input voltage source 420; the source node S of the switch Q11 is directly connected to the drain node D of the switch Q12; the source node of the switch Q12 is directly connected to the ground reference voltage 199.

Capacitor COUT stores the output voltage VOUT generated by the combination of power converter phases 120-X1, 120-X2, etc.

As previously discussed, the network of electrically conductive paths 275 (FIG. 2) or network of electrically conductive paths 375 (FIG. 3) provides connectivity between components in the power converter assembly 120 (different instances of power converter assembly 120-X, power converter assembly 120-Y, etc.).

For example, one or more of the capacitors 220 in FIG. 2 (where capacitors 220 may include one or more of capacitor CD1, bootstrap capacitor CB1, capacitor CIN, capacitor COUT) may be disposed in layer L2 of the power converter assembly 120-X. In such an instance, a first node of the capacitor CD1 can be connected to the ground reference voltage 199 via an electrically conductive path from the first node of the capacitor CD1 from the layer L2 through the layer L1 to the substrate 255 providing the ground reference voltage 199. The second node of the capacitor CD1 in the layer L2 may be connected to the driver circuitry 210-1 in the layer L1 via connectivity provided by a portion of the network of electrically conductive paths 275 from the second node of the capacitor CD1 to the driver circuitry 210-1 in the layer L1.

Additionally, a first node of the capacitor CB1 (one of capacitors 220) in the layer L2 can be connected to the driver circuitry 210-1 in the layer L3 via a first electrically conductive path of the conductive paths 275. A second node of the capacitor CB1 can be connected to the node N41 (such as in layer L3 or other layer) via a second electrically conductive path of the conductive paths 275 or conductive paths 375.

Further, the substrate 255 may convey the input voltage VIN from the voltage source 420 through the component layer L1. In one example, the capacitor CIN may be disposed in the layer L2. In such an instance, a first node of the capacitor CIN may be connected to the ground reference voltage 199 via one or more of the electrically conductive path of conductive paths 275 extending from a first node of the capacitor CIN in layer L2 through the layer L1 to the substrate 255 providing the ground reference voltage 199. The second node of the capacitor CIN such as in the layer L2 may be connected to the input voltage source 420 such as via connectivity provided by electrically conductive path extending from the substrate 255 through the layer L1 to the second node of the capacitor CIN.

Further, the capacitor COUT storing the output voltage Vout may be disposed in the layer L2 of the power converter assembly. The first node of the capacitor COUT may be connected to node N49 while a second node of the capacitor COUT is connected to the ground reference voltage 199.

### Power Converter 120-X2

For example, a second power converter 120-X2 may be disposed in the respective power converter assembly 120-X and may be configured to include a capacitor CD2, driver circuitry 210-2, bootstrap capacitor CB2, switch Q21, switch Q22, and inductor 240-2. In one example, the combination of switch Q21, switch Q22, and inductor 240-2 (electrically conductive path) is a buck converter.

The capacitor CD2 can be configured to store a respective voltage used by the driver circuitry 210-2 to produce respective drive signals DS21 and DS22 to control respective switch Q21 and switch Q22. In general, during operation of converting the input voltage Vin into the output voltage Vout, the controller 140 is configured to activate one of the multiple switches Q21 and Q22 during a respective control cycle to control conveyance of a respective current through the inductor 240-2 to the capacitor COUT and corresponding load 118.

More specifically, for a first portion of a control cycle of controlling the respective switches Q21 and Q22, the controller 140 generates the control signals S21 causing the driver circuitry 210-2 to produce the control signal DS21 to activate the switch Q21 to an ON-state (i.e., low impedance path) and produce the control signal DS22 to deactivate the switch Q22 to an OFF-state (i.e., high impedance path). Conversely, for a second portion of a control cycle of controlling the respective switches Q21 and Q22, the controller 140 generates the control signals S21, causing the driver circuitry 210-2 to produce the control signal DS21 to deactivate the switch Q21 to an OFF-state (i.e., high impedance path) and produce the control signal DS22 to activate the switch Q22 to an ON-state (i.e., low impedance path).

As further shown, the capacitor CIN stores the input voltage VIN supplied by the power source 420.

The capacitor CB2 is a so-called bootstrap capacitor connected between the driver circuitry 210-2 and the node N42. The node N42 directly connects the switch Q21 and the switch Q22 in series between the node N40 and the ground reference voltage 199.

Capacitor COUT stores the output voltage VOUT generated by the combination of power converter phases 120-X1, 120-X2, etc.

As previously discussed, the network of electrically conductive paths 275 (FIG. 2) or network of electrically conductive paths 375 (FIG. 3) provides connectivity between components in the power converter assembly 120 (different instances of power converter assembly 120-X, power converter assembly 120-Y, etc.).

For example, one or more of the capacitors 220 in FIG. 2 (where capacitors 220 may include one or more of capacitor CD2, bootstrap capacitor CB2, capacitor CIN, capacitor COUT) may be disposed in layer L2 of the power converter assembly 120-X. In such an instance, a first node of the capacitor CD2 can be connected to the ground reference voltage 199 via an electrically conductive path from the first node of the capacitor CD2 from the layer L2 through the layer L1 to the substrate 255 providing the ground reference voltage 199. The second node of the capacitor CD2 in the layer L2 may be connected to the driver circuitry 210-2 in the layer L1 via connectivity provided by a portion of the network of electrically conductive paths 275 from the second node of the capacitor CD2 to the driver circuitry 210-2 in the layer L1.

Additionally, a first node of the capacitor CB2 (one of capacitors 220) in the layer L2 can be connected to the driver circuitry 210-2 in the layer L3 via a first electrically conductive path of the conductive paths 275. A second node of the capacitor CB2 can be connected to the node N42 (such as in layer L3 or other layer) via a second electrically conductive path.

Each of the different instances of the power converter phases such as power converter phase 120-X3, 120-X4, etc., can be implemented as a similar manner as power converter phase 120-X1 or power converter phase 120-X 2 as previously discussed.

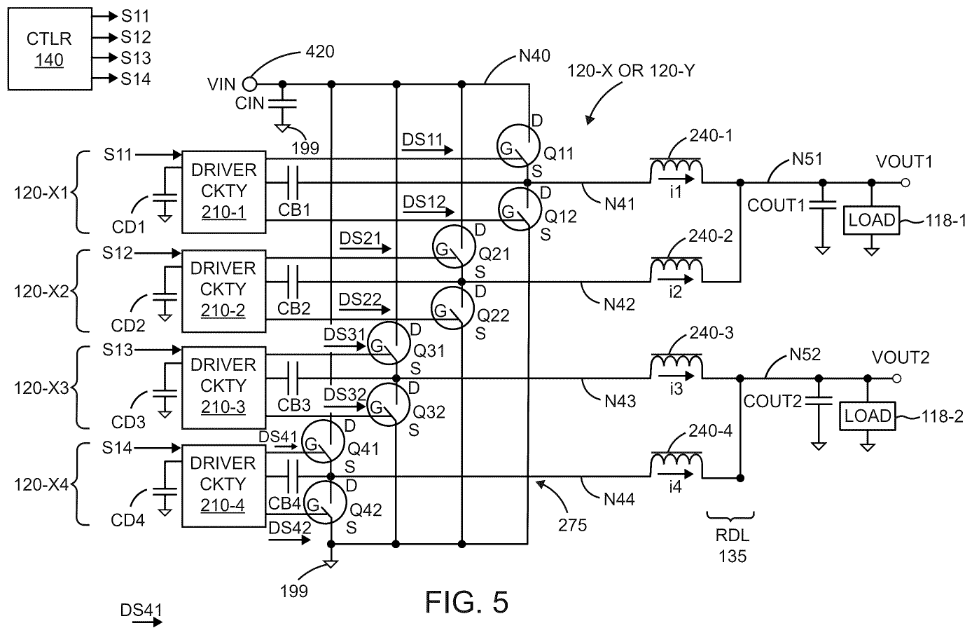

FIG. 5 is an example circuit diagram illustrating an implementation of multiple power converter phases in a power converter assembly as discussed herein.

In this example, instead of connecting all of the power converter phases 120-X1, 120-X2, 120-X3, and 120-X4 in parallel, the two power converters 120-X1 and 120-X2 are connected in parallel to produce the respective output voltage VOUT1 to power the corresponding load 118-1. Additionally, the two power converters 120-X3 and 120-X4 are connected in parallel to produce the respective output voltage VOUT2 to power the corresponding load 118-2.

More specifically, the driver circuitry 210-1 controls the respective switches Q11 and the Q12 such that the inductor 240-1 produces a respective output voltage VOUT1 (and corresponding output current i1) supplied to a combination of the capacitor COUT1 and the load 118-1. The driver circuitry 210-2 controls the respective switches Q21 and the Q22 such that the inductor 240-2 produces a respective output voltage VOUT1 (and corresponding output current i2) supplied to a combination of the capacitor COUT1 and the load 118-1.

The driver circuitry 210-3 controls the respective switches Q31 and the Q32 such that the inductor 240-3 produces a respective output voltage VOUT2 and corresponding output current i3 supplied to a combination of the capacitor COUT2 and the load 118-2. The driver circuitry 210-4 controls the respective switches Q41 and the Q42 such that the inductor 240-4 produces a respective output voltage VOUT2 and corresponding output current i4 supplied to a combination of the capacitor COUT2 and the load 118-2.

Thus, the power converter assembly 120-X or 120-Y can be configured to produce different output voltages depending upon how respective output nodes of the inductors 240 are connected at the redistribution layer 135 or other nodes in the power converter system as discussed herein.

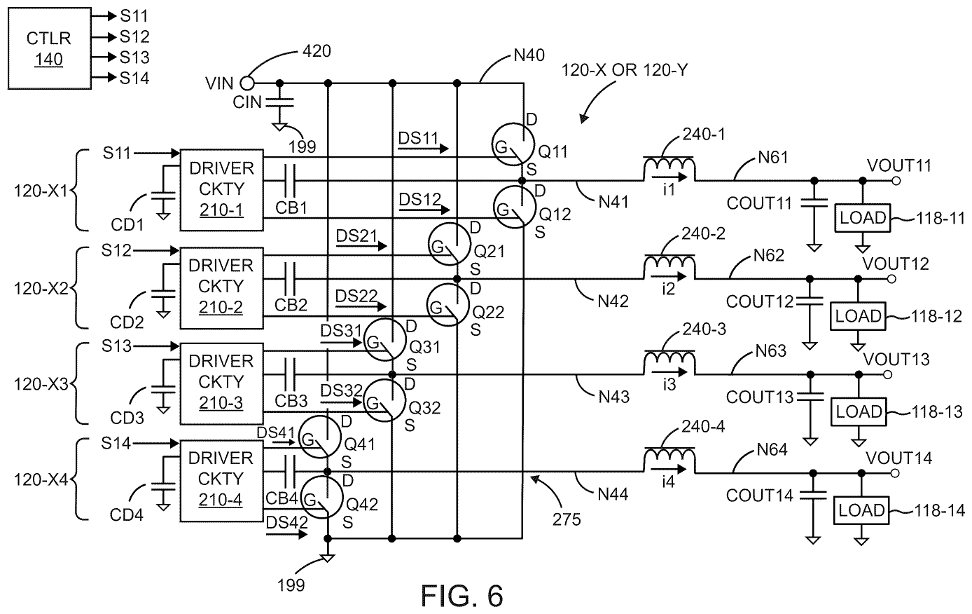

FIG. 6 is an example circuit diagram illustrating an implementation of multiple power converter phases in a power converter assembly as discussed herein.

In this example, instead of connecting all of the power converter phases 120-X1, 120-X2, 120-X3, and 120-X4 in parallel, each of the power converter phases in the power converter assembly 120-X or 120-Y are operated independently of each other to produce a respective output voltage.

For example, the power converter 120-X1 and corresponding circuitry such as including the capacitor COUT11 can be configured to produce the respective output voltage VOUT11 and corresponding output current i1 to power the load 118-11; the power converter 120-X2 and corresponding circuitry such as including the capacitor COUT12 can be configured to produce the respective output voltage VOUT12 and corresponding output current i2 to power the load 118-12; the power converter 120-X3 and corresponding circuitry such as including the capacitor COUT13 can be configured to produce the respective output voltage VOUT13 and corresponding output current i3 to power the load 118-13; the power converter 120-X4 and corresponding circuitry such as including the capacitor COUT14 can be configured to produce the respective output voltage VOUT14 and corresponding output current i4 to power the load 118-14.

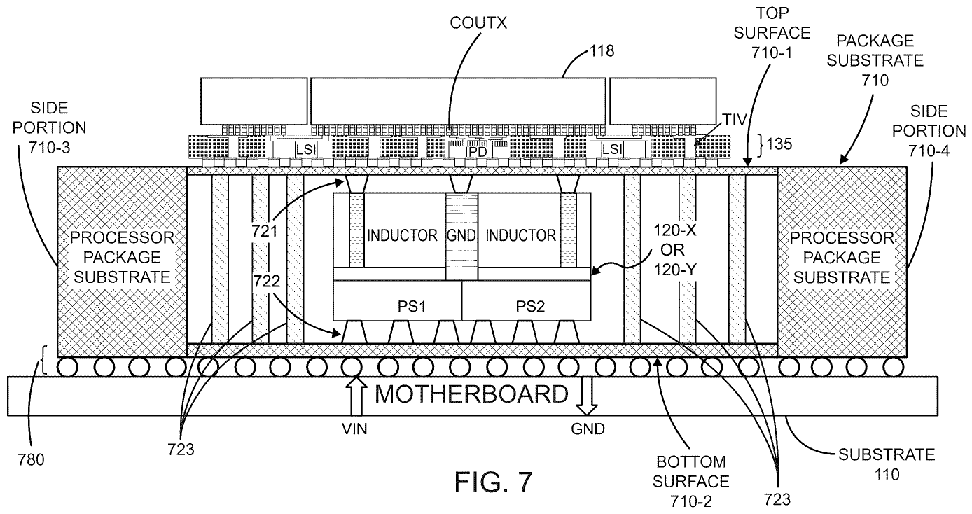

FIG. 7 is an example side view diagram of a power converter assembly disposed in a substrate and wherein the substrate is disposed between a host substrate and a load as discussed herein.

In this example, one or more instances of the power converter assembly 120-X or power converter assembly 120-Y are disposed in a respective packet substrate 710. The package substrate 710 can be configured to include a respective cavity in which the power converter assembly is disposed between a top surface 710-1 and the bottom surface 710-2 of the package substrate 710. It is further noted that the power converter assembly is disposed between the side portion 710-3 and side portion 710-4 of the packet substrate 710. Accordingly, the cavity in which the one or more instances of the power converter assembly reside is disposed between the top surface 710-1, bottom surface 710-2, side portion 710-3, and side portion 710-4 of the packet substrate 710.

As further shown, note that the output capacitors such as represented at least in part by the one or more capacitors COUTX can be disposed in the redistribution layer 135 disposed between the load 118 and the top surface 710-1 of the packet substrate 710.

Yet further, as shown, the package substrate 710 can be configured to include electrically conductive paths 721 extending between the power converter assembly and the redistribution layer 135. A first portion of the electrically conductive paths 721 can be configured to supply the output voltages generated from the power converter assembly. A second portion of the electrically conductive paths can be configured to support a return path for current to the ground (GND) node of the power converter assembly.

The package substrate 710 can be configured to include electrically conductive paths 722 extending between the power converter assembly and the connection interface 780. A first portion of the electrically conductive paths 722 can be configured to supply one or more input voltages to the power converter assembly. A second portion of the electrically conductive paths can be configured to provide a return path for current to the ground (GND) node of the power converter assembly.

Additionally, as shown, the package substrate 710 can be configured to include electrically conductive paths 723, where the electrically conductive paths that extend through the cavity of the packet substrate 710 and, as shown, directly connect nodes of the connection interface 780 to nodes on the distribution layer 135.

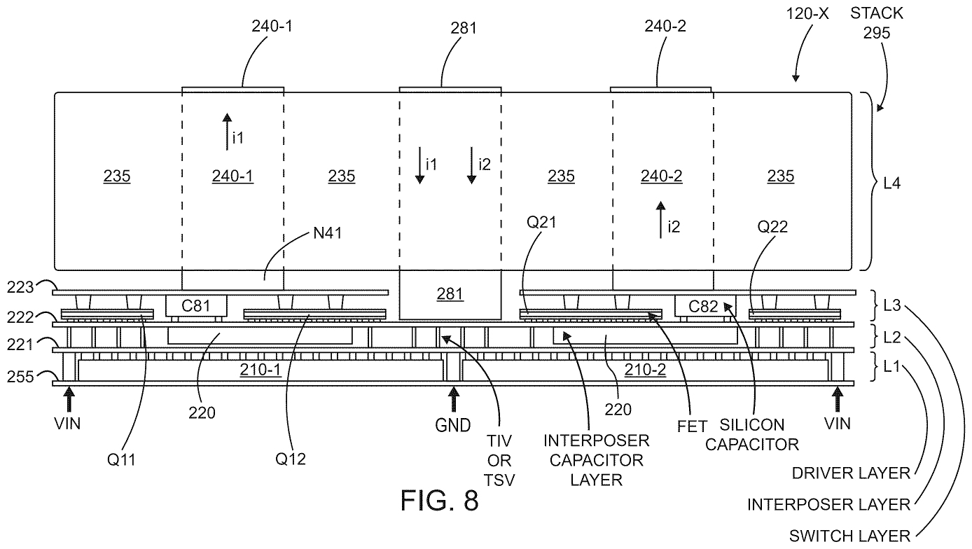

FIG. 8 is an example side view diagram illustrating a multilayer power converter assembly as discussed herein.

As previously discussed in FIG. 2, the power converter assembly 120 can be configured to include multiple layers such as layers L1, L2, L3, and L4.

As shown in FIG. 8, the electrically conductive path 240-1 extends through the magnetically permeable material 235 in layer 4 of the power converter assembly 120-X. A first axial end of the electrically conductive path 240-1 (node N41) is connected to a top surface of the redistribution layer 223. The second axial end of the electrically conductive path 240-1 outputs the current i1 to the corresponding load 118 in a manner as previously discussed. The redistribution layer 223 provides connectivity of the node N41 associated with the electrically conductive path 240-1 to a combination of the source node S of switch Q11 and the drain node D of switch Q12, wherein the switch Q11 and the switch Q12 are disposed in the switch layer L3. As previously discussed, the switch layer L3 can be configured to include a capacitor C81 (such as bootstrap capacitor CB1 or other capacitors associated with the power converter 120-X1) disposed in the layer L3 between the switch Q11 and switch Q12. In other words, one or more capacitors 220 such as capacitor CD1, capacitor CB1, capacitor CIN, capacitor COUT, etc., may be disposed in the layer L2 between the driver circuitry 210-1 in layer L1 and the switches Q11 and the Q12 in layer L3.

As previously discussed, this stacking and corresponding layout of components associated with the power converter 120-X1 in the respective stack 295 provide a useful implementation of a power converter in a small form factor.

As further shown, the electrically conductive path 240-2 extends through the magnetically permeable material 235 in layer 4 of the power converter assembly 120-X. A first axial end of the electrically conductive path 240-2 (node N42) is connected to the redistribution layer 223. The second axial end of the electrically conductive path 240-2 outputs the current i2 to the corresponding load 118. The redistribution layer 223 provides connectivity of the node N42 associated with the electrically conductive path 240-2 to a combination of the source node S of switch Q21 and the drain node D of switch Q22 disposed in the switch layer L3. As previously discussed, the switch layer L3 can be configured to include a capacitor C82 (such as bootstrap capacitor CB2 or other capacitor in the power converter 120-X2 or silicon capacitor or other suitable entity) disposed in the layer L3 between the switch Q21 and switch Q22. One or more capacitors 220 such as capacitor CD2, capacitor CB2, capacitor CIN, capacitor COUT, etc., may be disposed in the layer L2 between the driver circuitry 210-2 in layer L1 and the switches Q21 and the Q22 in layer L3. As previously discussed, this stacking and corresponding layout of components associated with the power converter 120-X2 in the respective stack 295 provide a useful implementation of a power converter in a small form factor.

As further shown, the power converter assembly 120-X further includes electrically conductive path 281 providing a circuit path in which to convey return current i1 and i2 from the load 118 back to the reference voltage 199 associated with the host substrate 110.

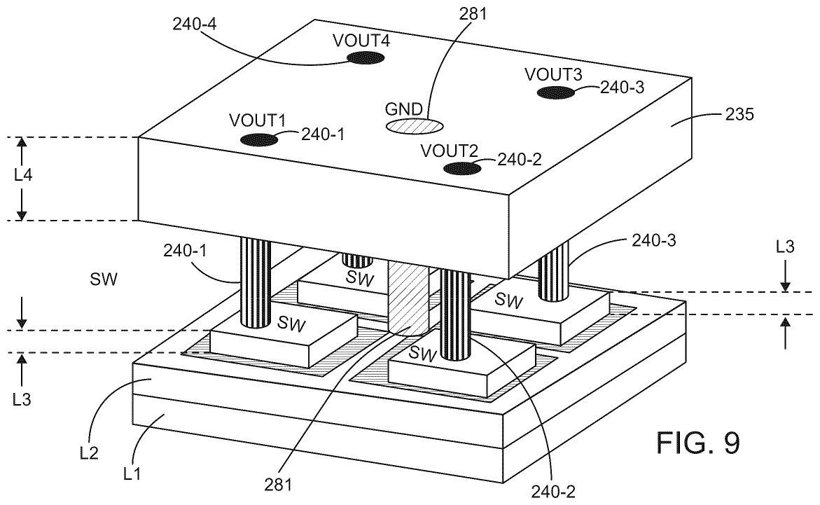

FIG. 9 is an example three-dimensional diagram illustrating implementation of a multilayer power converter circuit as discussed herein.

As previously discussed, in the power converter assembly 120-X, the layer L4 includes magnetic permeable material through which the electrically conductive paths 240 (such as electrically conductive path 240-1, electrically conductive path 240-2, electrically conductive path 240-3, and electrically conductive path 240-4) reside. Additionally, as shown, the switch circuitry such as switch Q11, switch Q12, switch Q21, switch Q22, etc., resides in layer L3.

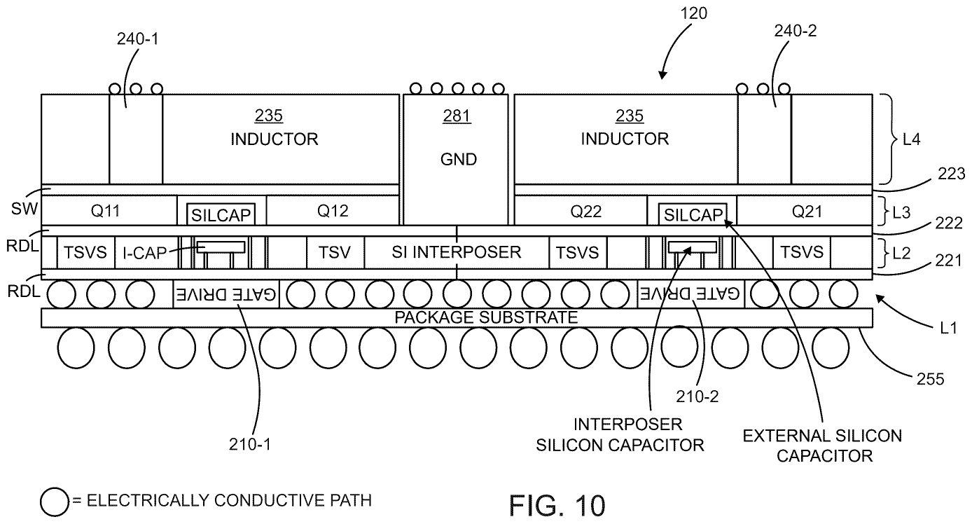

### FIG. 10 is an example side view diagram illustrating a power converter assembly as discussed herein.

In this example, the layer L2 is fabricated as a silicon interposer including one or more silicon capacitors for implementing any of the capacitors as discussed herein. Additionally, the layer L2 further includes multiple so-called through silicon vias (TSV), which are electrically conductive paths extending from the layer L1 to the redistribution layer 222. Layer L1 includes a combination of electrically conductive paths (shown as circles or solder balls) as well as corresponding driver circuitry 210-1, driver circuitry 210-2, etc. The multiple so-called through silicon vias therefore support vertical flow of current (power) from the substrate 255 to the corresponding load 118 disposed above the power converter assembly 120.

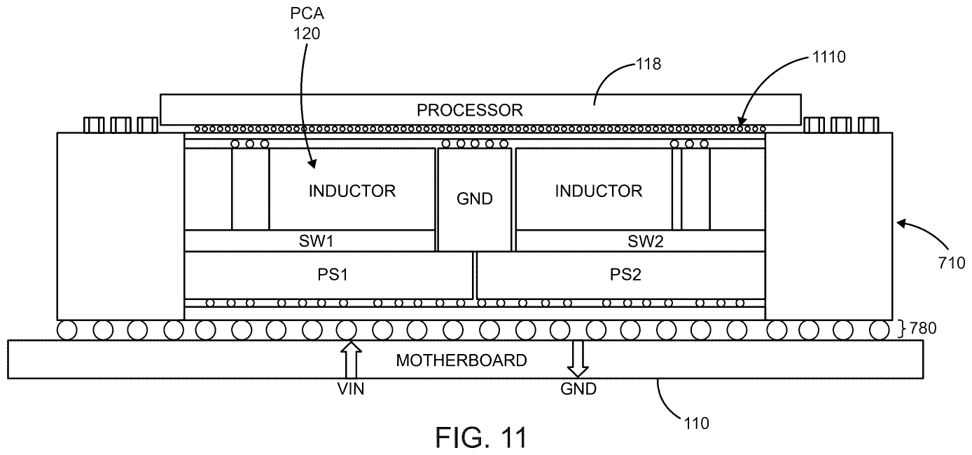

FIG. 11 is an example side view diagram of a power converter assembly disposed in a substrate (such as a processor package substrate) and where the substrate is disposed between a host substrate and a load as discussed herein.

In this example, the power converter assembly 120 resides in the processor package substrate 710, where a top surface of the processor package substrate 710 provides a respective connection interface 1110 between the top surface of the processor package substrate 710 and the load 118 (such as a processor or the circuit components). In a similar manner as previously discussed, the processor package substrate 710 can be connected to the host substrate 110 via the connection interface 780.

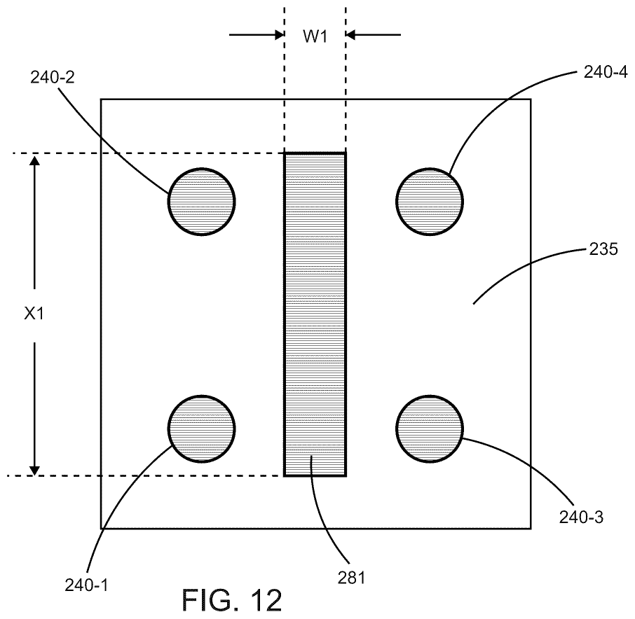

FIG. 12 is a top view diagram of a power converter assembly illustrating multiple electrically conductive paths passing through magnetically permeable material as discussed herein.

As previously discussed, the power converter assembly can be configured to include an electrically conductive path 281 to support return current from the load 118 to a ground reference voltage 199. In this example, instead of a cylindrical electrically conductive path, the electrically conductive path 281 can be configured to extends lengthwise to have a length equal to X1 and a width W1 through the magnetically permeable material 235. Accordingly, the electrically conductive paths as discussed herein can be configured in any suitable manner and shape.

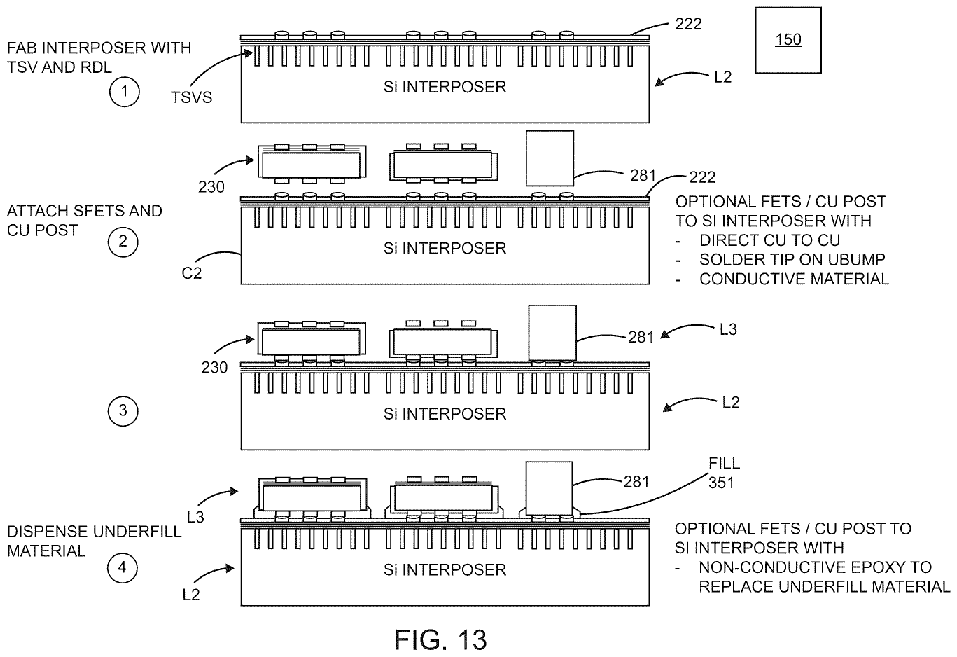

FIG. 13 is an example side diagram illustrating fabrication of a power converter assembly as discussed herein.

In this example, in processing operation #1, the fabricator 150 produces the layer L2 such as a silicon interposer to include one or more through silicon vias TSV as well as a redistribution layer 222.

In processing operation #2 and #3, the fabricator 150 affixes one or more instances of switch circuitry 230 to the redistribution layer 222. Additionally, the fabricator 150 couples the electrically conductive path 281 (such as metal) to the redistribution layer 222.

In processing operation #4, the fabricator 150 applies material 351 such as epoxy or other suitable nonconductive material or insulator material to underfill the switch circuitry 230 and the electrically conductive path 281.

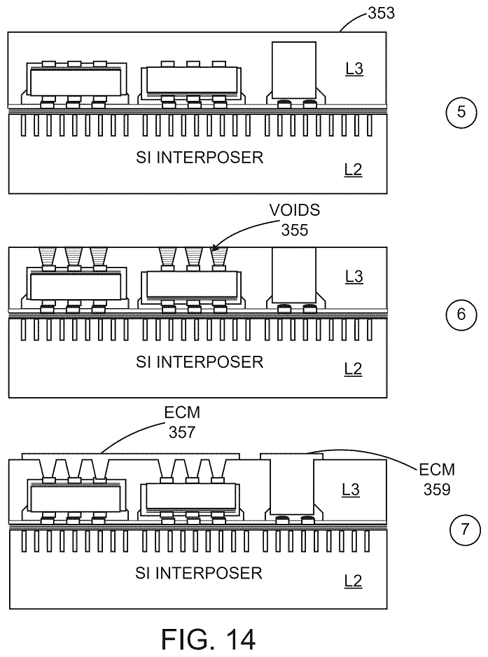

Further processing is illustrated and discussed in FIG. 14.

FIG. 14 is an example side diagram illustrating fabrication of the power converter assembly is discussed herein.

In processing operation #5, the fabricator 150 applies the over-mold material 353 (non-electrically conductive material or insulator material), encompassing or enveloping the switch circuitry 230 and the electrically conductive path 281 affixed to the layer L2.

In processing operation #6, the fabricator 150 produces the laser vias 355 in the over-mold material 353.

In processing operation #7, the fabricator 150 applies the electrically conductive material 357 such as metal into the voids 350. Additionally, the fabricator 150 applies the electrically conductive material 359 such as metal to the surface of the electrically conductive path 281.

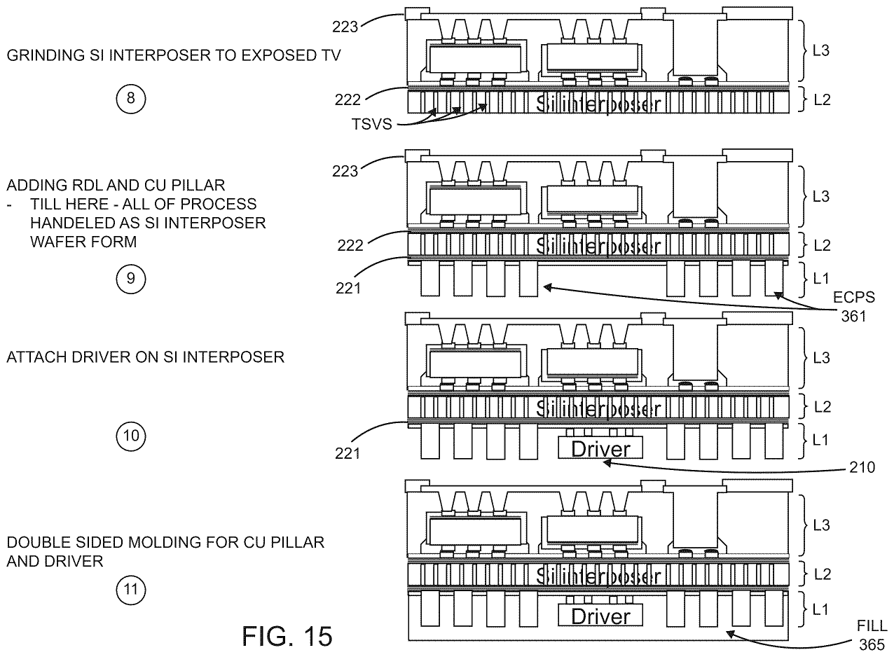

Further processing is illustrated and discussed in FIG. 15.

FIG. 15 is an example side diagram illustrating fabrication of a power converter assembly as discussed herein.

In processing operation #8, the fabricator 150 grinds a bottom surface of the layer L2 (such as a silicon interposer layer) to expose the through silicon vias TSV extending between the bottom surface of layer L2 and the redistribution layer 222.

In processing operation #9, the fabricator 150 produces the electrically conductive paths 361 in the layer L1.

In processing operation #10, the fabricator 150 affixes the respective driver circuitry 210 to a bottom surface of the redistribution layer 221.

In processing operation #11, the fabricator 150 applies a respective insulator material 365 to encompass the driver circuitry 210 as well as the electrically conductive paths 365 in the layer L1.

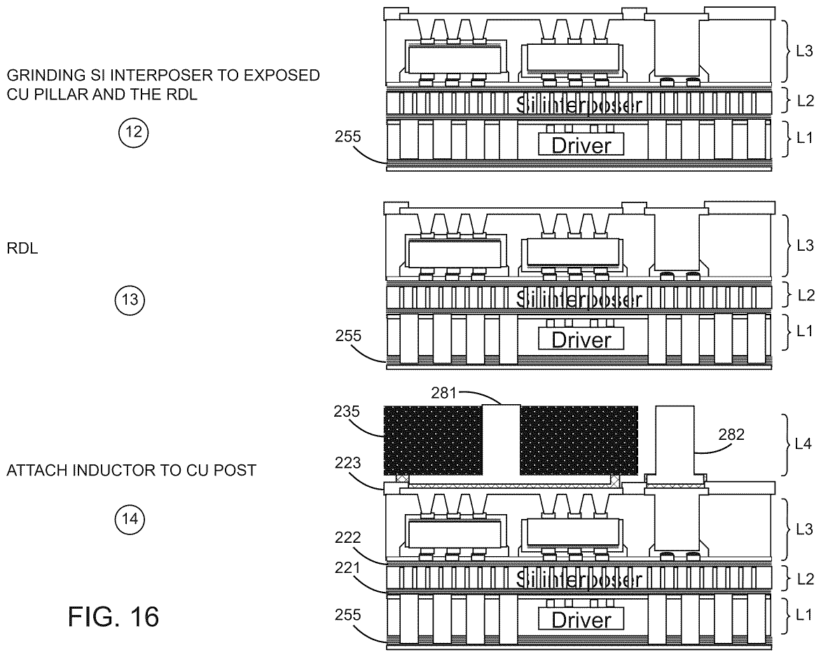

Further processing is illustrated and discussed in FIG. 16.

FIG. 16 is an example side diagram illustrating fabrication of a power converter assembly as discussed herein.

In processing operation #12 and #13, the fabricator 150 removes a bottom portion of the layer L1 to expose the electrically conductive paths 365. The fabricator 150 then fabricates the redistribution layer 255 on the exposed bottom surface of the layer L1.

In processing operation #14, the fabricator 150 fabricates the layer L4 to include magnetically permeable material 235 as well as corresponding electrically conductive paths such as electrically conductive path 281, electrically conductive path 282, etc.

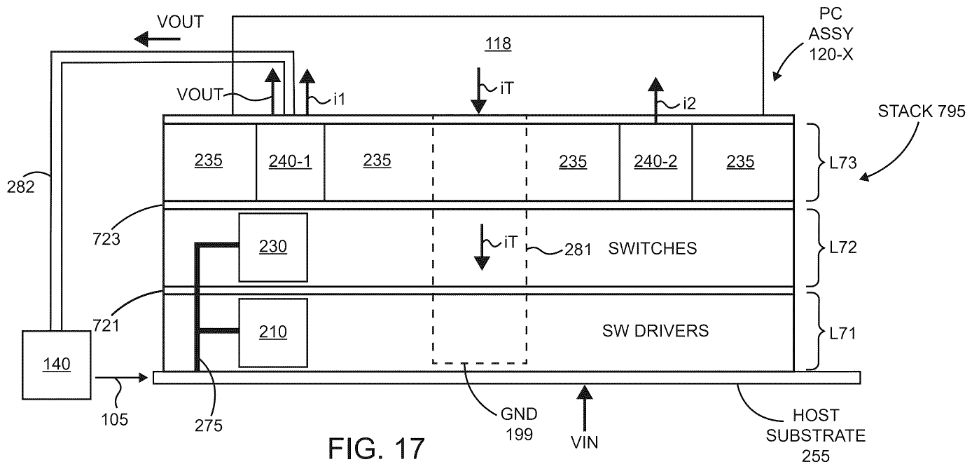

FIG. 17 is an example circuit diagram illustrating stacking of circuit components in a power converter assembly as discussed herein.

In this example, the power converter assembly 120-X (such as illustrating each instance of power converter assembly 120-1 [X=1], power converter assembly 120-2 [X=2], power converter assembly 120-3 [X=3], power converter assembly 120-4 [X=4], etc.) can be configured to include multiple layers (stack) of circuit components.

Further, in this example of FIG. 17 and corresponding stack of circuit components 795, assume that there are no capacitors implemented in the respective power converter circuits in FIGS. 4 through 6. In such an instance, the stack of circuit component 795 not include a capacitor layer.

More specifically, referring again to FIG. 17, in this example, the stack 795 of circuit components associated with the power converter assembly 120-X (such as an instance of the power converter assembly 120-1, power converter 120-2, power converter 120-3, etc.) includes a first layer L71 of circuit components including switch driver circuitry and potentially other circuitry; a second layer L72 of circuit components including one or more instances of switch circuitry and potentially other circuitry; and a third layer L73 of circuit components including one or more inductors and/or electrically conductive paths.

In a manner as previously discussed, the switch circuitry 230 (such as one or more switches) disposed in the layer L72 are controlled by the switch driver circuitry 210 (such as one or more driver circuits) disposed in the first layer L71.

It is further noted that the power converter assembly 120-X in a corresponding stack of circuit component 795 can be configured to include any number of so-called redistribution layers (a.k. a., substrates, printed circuit boards, etc.).

For example, the power converter assembly 120-X or stack of circuit component 795 can be configured to include a redistribution layer 721 disposed between the layer L71 and the second layer L72. The power converter assembly 120-X can be configured to include a redistribution layer 722 disposed between the second layer L72 and the layer L73.

Yet further, as shown, the layer L73 can be configured to include any number of electrically conductive paths extending through the magnetically permeable material 235. For example, the electrically conductive paths 240 in the layer L73 can be configured to include electrically conductive path 240-1, electrically conductive path 240-2, electrically conductive path 240-3, electrically conductive path 240-4, etc.

In a manner as previously discussed, each of the electrically conductive paths 240 in the fourth layer L4 may be surrounded by the magnetically permeable material 235. In such an instance, each of the electrically conductive paths 240 in the layer L73 is an inductor device operative to support vertical conveyance of power (such as current) through the stack 795 from the layer L73 out the top of the respective stack 795 of layers (L71, L72, L73).

As further discussed herein, the power converter assembly 120-X (and corresponding stack 795) can be configured to include any suitable network of electrically conductive paths 275 providing connectivity amongst the different layers in the stack 795 including component layers L71, L72, and L73. It is noted that the electrically conductive paths 275 may extend vertically from one redistribution layer to the next redistribution layer. Additionally, the electrically conductive paths 275 may extend horizontally in the one or more redistribution layers.

Accordingly, as further discussed herein, the network of electrically conductive paths 275 can be configured to include multiple electrically conductive paths extending through each of the layers including layer L71, layer L72, layer L73, as well corresponding redistribution layer such as redistribution layer 721, redistribution layer 723, etc.

In one example, the controller 140 can be disposed in the stack 795 or outside of the stack 795 of layers. If desired, the capacitors as previously discussed can be disposed outside of the stack 795. Alternatively, as shown in FIG. 17, the capacitors CD1, CD2, CD3, CD4, CB1, CB2, CB3, CB4, etc., may not be present in the stack 795.

In a similar manner as previously discussed, note further that the controller 140 can be configured to generate control signals 105 to control operation of the respective switch circuitry 230 in layer L72 supporting control of current through the stack 795 out of the top of the stack 795 to the load 118.

Further, note that electrically conductive path 281 can be configured to extend through the stack 795 between the load 118 in the substrate 255. As previously discussed, the electrically conductive path 281 is connected between a node of the load 118 and a ground reference voltage 199 (a.k.a., ground reference potential). In one example, the electrically conductive path 281 through the stack 295 is enveloped by the magnetic permeable material 235. In such an instance, the electrically conductive path 281 is itself may be an inductor in a return path from the top of the power converter assembly 120-X through the stack 795 as shown to the ground reference 199. As previously discussed, the respective electrically conductive paths 240 can be configured to supply output voltage and corresponding current i1, i2, i3, and i4 to the load 118. The return path of the load 118 is connected to the electrically conductive path 281 carrying the total current iT (summation of currents i1, i2, i3, and i4) to the ground reference voltage 199 associated with the host substrate 255. In alternative examples, note that the electrically conductive path 281 may not pass through the stack 795 and instead be implemented in a clip or other conductive path outside of the stack 795.

### Example of Certain Configurations

Example 1. An apparatus comprising: a power converter assembly including a stack of power converter components, the power converter assembly operative to convert an input voltage into an output voltage, the stack of power converter components including: a first component layer including switch driver circuitry; a second component layer coupled to the first component layer, the second component layer including multiple switches controlled by the switch driver circuitry; a third component layer coupled to the second component layer, the third component layer including at least one inductor; and wherein the second component layer is disposed between the first component layer and the third component layer.

Example 2 The apparatus as in example 1 further comprising: a first redistribution substrate disposed between the first component layer and the second component layer; and a second redistribution substrate disposed between the second component layer and the third component layer.

Example 3 The apparatus as in example 2, wherein the third component layer includes: magnetically permeable material; and a first electrically conductive path encompassed by the magnetically permeable material, the first electrically conductive path extending axially from a first node disposed on a first surface of the third component layer and a second node disposed on a second surface of the third component layer, the second surface disposed opposite the first surface.

Example 4 The apparatus as in the example 3, wherein the first electrically conductive path is operative to convey first current received from the second component layer through the third component layer in a first direction to a load, the apparatus further comprising: a second electrically conductive path encompassed by the magnetically permeable material, the second electrically conductive path operative to convey the first current in a second direction from the load through the third component layer to the second component layer.

Example 5 An assembly comprising: a host substrate; the stack of circuit components as in example 1 coupled to the host substrate; a dynamic load coupled to the stack of circuit components; and wherein the stack of circuit components is disposed between the host substrate and the dynamic load, the stack of circuit components operative to receive the input voltage from the host substrate and supply the output voltage to the dynamic load.

Note again that techniques herein are well suited for use in a stacked power converters and power converter applications. However, it should be noted that techniques herein are not limited to use in such applications and that the techniques discussed herein are well suited for other applications as well.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

1. An apparatus comprising:
a power converter assembly including a stack of circuit components, the power converter assembly operative to convert an input voltage into an output voltage, the stack of circuit components including:
a first component layer including switch driver circuitry;
a second component layer including multiple switches controlled by the switch driver circuitry in the first component layer; and
a third component layer disposed between the first component layer and the second component layer, the third component layer comprising at least one capacitor component to support conversion of the input voltage into the output voltage.

2. The apparatus as in claim 1 further comprising:
electrically conductive paths extending through the third component layer, the electrically conductive paths operative to convey control signals from the switch driver circuitry to the multiple switches.

3. The apparatus as in claim 1 further comprising:
a first redistribution layer disposed between the first component layer and the third component layer; and
a second redistribution layer disposed between the third component layer and the second component layer.

4. The apparatus as in claim 1, wherein the multiple switches in the second component layer include a first switch circuit and a second switch circuit; and
a circuit component disposed in the second component layer between the first switch circuit and the second switch circuit.

5. The apparatus as in claim 1, wherein the at least one capacitor component includes:
a first capacitor operative to store the input voltage;
a second capacitor operative to store a driver voltage used by the switch driver circuitry; and
a third capacitor operative to store the output voltage.

6. The apparatus as in claim 1, wherein the at least one capacitor component in the third component layer includes:
a bootstrap capacitor connected between the switch driver circuitry in the first component layer and a first axial end of a first electrically conductive path in a third component layer of the power converter assembly.

7. The apparatus as in claim 1, wherein the stack of circuit components further includes:
a fourth component layer comprising:
magnetically permeable material; and
a first electrically conductive path encompassed by the magnetically permeable material.

8. The apparatus as in claim 7, wherein the first electrically conductive path is operative to convey first current in a first direction away from the second component layer through the fourth component layer to a load, the power converter assembly further comprising:
a second electrically conductive path encompassed by the magnetically permeable material, the second electrically conductive path operative to convey the first current in a second direction from the load through the fourth component layer.

9. The apparatus as in claim 8, wherein the second electrically conductive path is a single homogeneous element of metal extending through the fourth component layer, the second electrically conductive path disposed between the first electrically conductive path and a third electrically conductive path in the fourth component layer, the third electrically conductive path operative to convey second current in the first direction to the load.

10. The apparatus as in claim 1 further comprising:
a host substrate;
a load; and
wherein the stack of circuit components is disposed between the host substrate and the dynamic load, the stack of circuit components operative to receive the input voltage from the host substrate and supply the output voltage to the dynamic load.

11. The apparatus as in claim 1, wherein the second component layer includes at least one capacitor.

12. The apparatus as in claim 1 further comprising:
a host package substrate including a cavity; and
wherein the stack of circuit components is disposed in the host package substrate.

13. The apparatus as in claim 1, wherein the third component layer is fabricated from:
i) glass,
ii) silicon; or
iii) a multi-compound layer of material.

14. An apparatus comprising:
a power converter assembly including a stack of power converter components, the power converter assembly operative to convert an input voltage into an output voltage, the stack of power converter components including:
a first component layer including at least one capacitor component;
a second component layer coupled to the first component layer, the second component layer including switch driver circuitry and multiple switches, the multiple switches controlled by the switch driver circuitry;
a third component layer coupled to the second component layer, the third component layer including at least one inductor; and
wherein the second component layer is disposed between the first component layer and the third component layer.

15. The apparatus as in claim 14 further comprising:
a first redistribution substrate disposed between the first component layer and the second component layer; and
a second redistribution substrate disposed between the second component layer and the third component layer.

16. The apparatus as in claim 14, wherein the at least one capacitor component includes:
a first capacitor operative to store the input voltage; and
a second capacitor operative to store a driver voltage used by the driver circuitry.

17. The apparatus as in claim 1, wherein the third component layer includes:
magnetically permeable material; and
a first electrically conductive path encompassed by the magnetically permeable material, the first electrically conductive path extending axially from a first node disposed on a first surface of the third component layer and a second node disposed on a second surface of the third component layer, the second surface disposed opposite the first surface.

18. The apparatus as in claim 17, wherein the first electrically conductive path is operative to convey first current received from the second component layer through the third component layer in a first direction to a load, the apparatus further comprising:
a second electrically conductive path encompassed by the magnetically permeable material, the second electrically conductive path operative to convey the first current in a second direction from the load through the third component layer to the second component layer.

19. The apparatus as in claim 18, wherein the second electrically conductive path is a single homogeneous element of metal extending through the third layer, the second electrically conductive path disposed between the first electrically conductive path and a third electrically conductive path in the third component layer, the third electrically conductive path operative to convey second current in the first direction; and
wherein the second electrically conductive path is operative to convey the second current in the second direction from the load through the third component layer to the second component layer.

20. An assembly comprising:
a host substrate;
the stack of circuit components as in claim 14 coupled to the host substrate;
a dynamic load coupled to the stack of circuit components; and
wherein the stack of circuit components is disposed between the host substrate and the dynamic load, the stack of circuit components operative to receive the input voltage from the host substrate and supply the output voltage to the dynamic load.
